(19) United States
(12) Patent Application Publication
(10) Pub. No.: US 2022/0351727 A1
(43) Pub. Date: Nov. 3, 2022

(54) CONVERSATON METHOD, CONVERSATION SYSTEM, CONVERSATION APPARATUS, AND PROGRAM

(71) Applicant: NIPPON TELEGRAPH AND TELEPHONE CORPORATION, Tokyo (JP)

(72) Inventors: Hiroaki SUGIYAMA, Tokyo (JP); Hiromi NARIMATSU, Tokyo (JP); Masahiro MIZUKAMI, Tokyo (JP); Tsunehiro ARIMOTO, Tokyo (JP)

(73) Assignee: NIPPON TELEGRAPH AND TELEPHONE CORPORATION, Tokyo (JP)

(21) Appl. No.: 17/764,164

(22) PCT Filed: Oct. 3, 2019
(86) PCT No.: PCT/JP2019/039146

§ 371 Date: Mar. 25, 2022

(51) Int. Cl. G10L 15/22; G10L 15/08

(52) U.S. Cl. CPC G10L 15/22; G10L 15/08; G10L 2015/225; G10L 2015/223; G10L 2015/221

(57) ABSTRACT

An object is to give the user the impression that the system has sufficient dialogue capabilities. A humanoid robot (50) presents a first system speech to elicit information regarding a user's experience in a subject contained in a dialogue. A microphone (11) accepts a first user speech spoken by a user (101) after the first system speech has been spoken. When the first user speech is a speech that contains information regarding the user's experience, the humanoid robot (50) presents a second system speech to elicit information regarding the user's evaluation of the user's experience. The microphone (11) accepts a second user speech spoken by the user (101) after the second system speech has been spoken. When the second user speech is a speech that contains the user's positive or negative evaluation, the humanoid robot (50) presents a third system speech to sympathizes with the positive or negative evaluation.

### TECHNICAL FIELD

The present invention relates to a technique that is applicable to a robot or the like that communicates with a human, with which a computer has dialogue with a human, using a natural language or the like.

### BACKGROUND ART

Dialogue systems in various forms have been put to practical use, such as a dialogue system that recognizes a user's voice speech, generates a response sentence to the speech, synthesizes a voice, and utters the voice using a robot or the like, and a dialogue system that accepts a user's speech made by inputting a text, and generates and displays a response sentence to the speech. In recent years, attention has been focused on a chat dialogue system for chatting, which is different from conventional task-oriented dialogue systems (see Non Patent Literature 1, for example). A task-oriented dialogue is a dialogue that aims to efficiently achieve a task with a different clear goal through a dialogue. Unlike a task-oriented dialogue, a chat is a dialogue that aims to gain fun and satisfaction from the dialogue itself. That is, it can be said that a chat dialogue system is a dialogue system that aims to entertain and satisfy people through dialogues.

The mainstream of research for conventional chat dialogue systems is the generation of natural responses to speeches (hereinafter also referred to as “user speeches”) made by users on various topics (hereinafter, also referred to as an “open domain”). So far, the goal has been to be able to somehow respond to any user species in open domain chats, and efforts have been made to generate appropriate response speeches in a question-and-answer format, and to realize dialogues of several minutes by properly combining such speeches.

### CITATION LIST

### Non Patent Literature

Non Patent Literature 1: Higashinaka, R., Imamura, K., Meguro, T., Miyazaki, C., Kobayashi, N., Sugiyama, H., Hirano, T., Makino, T., and Matsuo, Y., “Towards an open-domain conversational system fully based on natural language processing,” in Proceedings of the 25th International Conference on Computational Linguistics, pp. 928-939, 2014.

### SUMMARY OF THE INVENTION

### Technical Problem

However, open-domain response generation does not directly lead to the achievement of the original goal of the chat dialogue system, which is to entertain and satisfy people through dialogues. For example, in a conventional chat dialogue system, even if topics are locally connected, the user may not be able to understand where the dialogue is heading in a big picture. As a result, the user feels stressed because they cannot interpret the intention of speeches made by the dialogue system (hereinafter, also referred to as “system speeches”) , or the dialogue system does not even understand its own speeches, and the user feels that system lacks dialogue capabilities, which is problematic.

In view of the above technical problem, an object of the present invention is to realize a dialogue system and a dialogue device capable of giving a user the impression that it has sufficient dialogue capabilities to correctly understand the user's speeches.

### Means for Solving the Problem

To solve the above problem, a dialogue method according to one aspect of the present invention is a dialogue method carried out by a dialogue system to which a personality is virtually set, including: a first speech presentation step of presenting a speech to elicit information regarding a user's experience in a subject contained in a dialogue; a first answer accepting step of accepting a user speech that responds to the speech presented in the first speech presentation step; a second speech presentation step of presenting a speech to elicit information regarding the user's evaluation of the user's experience in the subject when the user speech acquired in the first answer accepting step is a speech that contains a fact that the user has an experience in the subject; a second answer accepting step of accepting a user speech acquired in the second speech presentation step; and a third speech presentation step of, when the user speech acquired in the second answer accepting step is a speech that contains the user's positive or negative evaluation of the user's experience in the subject, presenting a speech to sympathize with the positive or negative evaluation.

### Effects of the Invention

According to this invention, it is possible to give the impression that the system has sufficient dialogue capabilities to correctly understand the user's speeches.

### BRIEF DESCRIPTION OF DRAWINGS

FIG. 1 is a diagram illustrating a functional configuration of a dialogue system according to a first embodiment.

FIG. 2 is a diagram illustrating a functional configuration of a speech determination unit.

FIG. 3 is a diagram illustrating processing procedures of a dialogue method according to the first embodiment.

FIG. 4 is a diagram illustrating processing procedures of a dialogue method according to the first embodiment.

FIG. 5 is a diagram illustrating processing procedures for system speech determination and presentation according to the first embodiment.

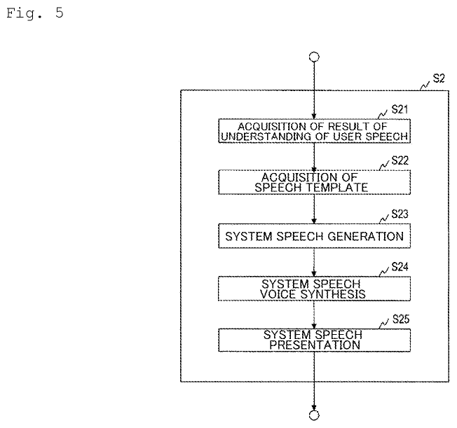

FIG. 6 is a diagram illustrating a functional configuration of a dialogue system according to a second embodiment.

FIG. 7 is a diagram illustrating a functional configuration of a computer.

### DESCRIPTION OF EMBODIMENTS

The following describes embodiments of the present invention in detail. Note that, in the drawings, the components that have the same function are given the same number, and duplicate descriptions will be omitted. In the dialogue system according to the present invention, an “agent” to which a virtual personality is set, such as a robot or a chat partner that is virtually set on the display of a computer, has dialogues with a user. Therefore, an embodiment in which a humanoid robot is used as an agent will be described as a first embodiment, and an embodiment in which a chat partner virtually set on a computer display is used as an agent will be described as a second embodiment.

### First Embodiment

### [Configuration of Dialogue System and Operations of Components]

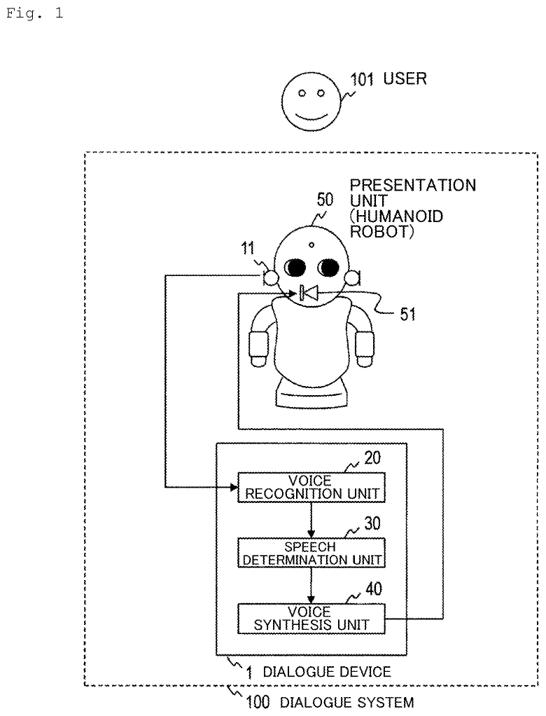

First, a configuration of a dialogue system according to the first embodiment and operations of the components thereof will be described. A dialogue system according to the first embodiment is a system in which one humanoid robot has dialogue with a user. As shown in FIG. 1, a dialogue system 100 includes, for example, a dialogue device 1, an input unit 10 constituted by a microphone 11, and a presentation unit 50 provided with at least a speaker 51. The dialogue device 1 includes, for example, a voice recognition unit 20, a speech determination unit 30, and a voice synthesis unit 40.

The dialogue device 1 is, for example, a special device formed by loading a special program into a well-known or dedicated computer that has a central processing unit (CPU) , a main storage device (RAM: Random Access Memory) , and so on. The dialogue device 1 performs various kinds of processing under the control of the CPU, for example. Data input to the dialogue device 1 or data obtained through various kinds of processing is, for example, stored in the main storage device, and the data stored in the main storage device is read out when needed and used for another kind of processing. At least a part of each processing unit of the dialogue device 1 may be formed using a piece of hardware such as an integrated circuit.

[Input Unit 10]

The input unit 10 may be integrated with, or partially integrated with, the presentation unit 50. In the example in FIG. 1, the microphone 11, which is a part of the input unit 10, is mounted on the head (at the position of an ear) of a humanoid robot 50, which is the presentation unit 50.

The input unit 10 is an interface for the dialogue system 100 to acquire the user's speech. In other words, the input unit 10 is an interface for inputting the user's speech to the dialogue system 100. For example, the input unit 10 is a microphone 11 that collects the user's spoken voice and converts it into a voice signal. The microphone 11 need only be capable of collecting the voice spoken by the user 101. That is to say, FIG. 1 is an example, and one microphone 11 or three or more microphones 11 may be provided. In addition, one or more microphones installed in a place different from where the humanoid robot 50 is located, such as the vicinity of the user 101, or a microphone array that includes a plurality of microphones may be employed as an input unit, and the humanoid robot 50 maybe configured without a microphone 11. The microphone 11 outputs the voice signal of the user's spoken voice obtained through the conversion. The voice signal output by the microphone 11 is input to the voice recognition unit 20.

[Voice Recognition Unit 20]

The voice recognition unit 20 performs voice recognition on the voice signal of the spoken voice of the user input from the microphone 11, to convert the voice signal into a text that represents the content of the user's speech, and outputs the text to the speech determination unit 30. The voice recognition method carried out by the voice recognition unit 20 may employ any of the existing voice recognition technologies, and a method suitable for the usage environment or the like may be selected.

[Speech Determination Unit 30]

The speech determination unit 30 determines the text representing the content of the speech from the dialogue system 100, and outputs the text to the voice synthesis unit 40. When a text representing the content of the user's speech is input from the voice recognition unit 20, the speech determination unit 30 determines the content of the speech from the dialogue system 100, based on the input text representing the content of the user's speech, and outputs the text to the voice synthesis unit 40.

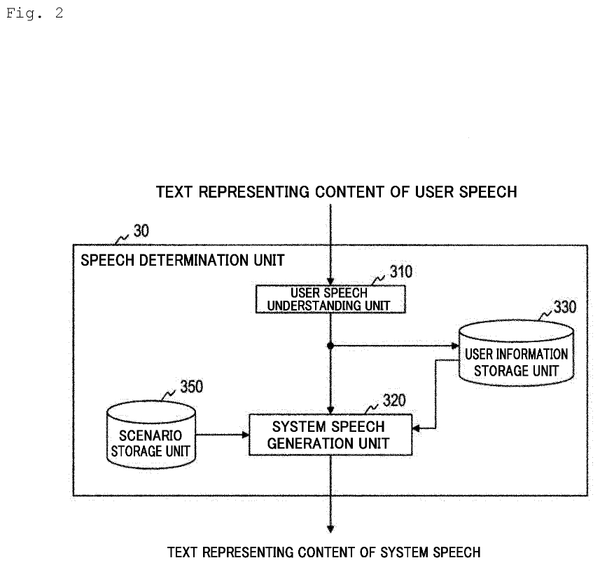

FIG. 2 shows a detailed functional configuration of the speech determination unit 30. The speech determination unit 30 receives a text representing the content of the user's speech input thereto, determines the text representing the content of the speech from the dialogue system 100, and outputs the text. The speech determination unit 30 includes, for example, a user speech understanding unit 310, a system speech generation unit 320, a user information storage unit 330, and a scenario storage unit 350.

[[User Information Storage Unit 330]]

The user information storage unit 330 is a storage unit that stores information regarding an attribute of the user acquired from the user's speech, based on various types of preset attributes. The attribute type is preset according to the scenario to be used in dialogue (i.e., a scenario stored in the scenario storage unit 350 described later). Examples of the types of attributes include a name, a residence prefecture, the experience of visiting a famous place in the residence prefecture, the experience of a famous place in the residence prefecture, and whether the evaluation of the experience of the famous place is a positive evaluation or a negative evaluation. Information regarding each attribute is extracted from the text representing the content of the user's speech input to the speech determination unit 30 by the user speech understanding unit 310, which will be described later, and is stored in the user information storage unit 330.

[[Scenario Storage Unit 350]]

The scenario storage unit 350 stores dialogue scenarios in advance. Each dialogue scenario stored in the scenario storage unit 350 includes transition of the state of the intention of a speech in the flow from the beginning to the end of the dialogue within a finite range, candidates for the intention of the speech of the previous user speech in each speech state of the dialogue system 100, candidates for system speech templates corresponding to the candidates for the intention of the previous user speech (i.e. templates for the content of a speech of for the dialogue system 100 to express the speech intention that does not contradict the speech intention of the previous user speech), and candidates for the speech intention of the next user speech corresponding to the candidates for the speech templates (i.e. candidates for the speech intention of the next user speech made for the speech intention of the dialogue system 100 in the candidates of the speech templates) . Note that the speech templates may include only the text representing the content of the speech of the dialogue system 100. Instead of a part of the text representing the content of the speech of the dialogue system 100, the speech templates may include information that specifies that certain types of attribute information regarding the user is to be included, for example.

[[User Speech Understanding Unit 310]]

The user speech understanding unit 310 acquires the result of understanding of the intention of the user's speech and attribute information regarding the user from the text representing the content of the user speech input to the speech determination unit 30, and outputs them to the system speech generation unit 320. The user speech understanding unit 310 stores the acquired attribute information regarding the user to the user information storage unit 330 as well.

[[System Speech Generation Unit 320]]

The system speech generation unit 320 determines a text representing the content of the system speech and outputs it to the voice synthesis unit 40. The system speech generation unit 320 acquires a speech template corresponding to the user's speech intention (i.e., the most recently input user speech intention) input from the user speech understanding unit 310 from among the speech templates corresponding to the candidates for the speech intention of the previous user speech in the current state in the scenario stored in the scenario storage unit 350. Next, in the case described below, the system speech generation unit 320 acquires attribute information of a predetermined type regarding th user from the user information storage unit 330, inserts the acquired information regarding the user into the speech template at a predetermined position, and determines it as a text representing the content of the system speech. Here, the case is a case in which the acquired speech template contains information specifying that the information regarding the user is to be included, and the information regarding the user has not been acquired from the user speech understanding unit 310.

[Voice Synthesis Unit 40]

The voice synthesis unit 40 converts the text representing the content of the system speech input from the speech determination unit 30 into a voice signal representing the content of the system speech, and outputs the voice signal to the presentation unit 50. The voice synthesis method carried out by the voice synthesis unit 40 may employ any of the existing voice synthesis technologies, and a method suitable for the usage environment or the like may be selected.

[Presentation Unit 50]

The presentation unit 50 is an interface for presenting the content of the speech determined by the speech determination unit 30 to the user. For example, the presentation unit 50 is a humanoid robot manufactured by imitating a human shape. This humanoid robot outputs a voice, i.e., presents a speech, corresponding to a voice signal representing the content of the speech input from the voice synthesis unit 40, for example, from the speaker 51 mounted on the head. The speaker 51 may be capable of outputting a voice corresponding to the voice signal representing the content of the speech input from the voice synthesis unit 40. That is to say, FIG. 1 is an example, and one speaker 51 or three or more speakers 51 may be provided. In addition, one or more speakers installed in a place different from where the humanoid robot 50 is located, such as the vicinity of the user 101, or a speaker array that includes a plurality of speakers may be provided, and the humanoid robot 50 may be configured without a speaker 51.

[Features of Dialogue Method Carried Out by Dialogue System According to Present Invention]

Next, the features of the dialogue method carried out by the dialogue system according to the present invention will be described based on specific examples of a dialogue between the dialogue system and the user. In the following specific example, “S” denotes a system speech, and “U” denotes a user speech. t (i) (i=0, 1, 2, . . . ) denotes a speech uttered during a dialogue, and i is a number indicating the order of the speech.

### SPECIFIC EXAMPLE 1

t(1) S: Hello! May I ask for your name?

t(2) U: My name is Sugiyama.

t(3) S: You are Sugiyama. I'm Riko. Nice to meet you. What prefecture do you live in, Sugiyama?

t(4) U: I live in Saitama prefecture.

t(5) S: I see, Saitama prefecture. I like Saitama. I'd like to go there. Nagatoro is famous, isn't it?

t (6) U: Nagatoro is close, so I sometimes go there by bicycle.

t(7) S: I'm jealous you have nice cherry blossoms. I love having a cherry-blossom viewing party. How are cherry blossoms in Nagatoro?

t (8) U: The row of cherry blossom trees along the Arakawa River is spectacular, and in the spring, it looks like a tunnel of cherry blossoms.

t(9) S: I love cherry blossoms. By the way, I live in Aomori prefecture, and when it comes to cherry blossoms, I recommend Hirosaki Castle. Have you been there, Sugiyama?

### SPECIFIC EXAMPLE 2

* t(1) to t(7) are the same as those in Specific Example 1, and are therefore omitted.

t(8′) U: Well, I don't know.

t(9′) S: Isn't it so beautiful?

[Features of Present Invention]

The following describes the features of the dialogue method carried out by the dialogue system according to the present invention with reference to Specific Examples 1 and 2.

[[Example 1-1]] “I'd like to go there. Nagatoro is famous, isn't it?” in System Speech t (5) , “I love having a cherry-blossom viewing party. How are cherry blossoms in Nagatoro?” in System Speech t (7) , and “I love cherry blossoms” in System Speech t(9) in Specific Example 1

“I love cherry blossoms” in the system speech t (9) is a speech that appropriately sympathizes with the positive evaluation of the user's experience expressed in “The row of cherry blossom trees along the Arakawa River is spectacular, and in the spring, it looks like a tunnel of cherry blossoms” in the previous user speech t(8). In order to elicit the user speech t(8) that contains the user's evaluation, to be sympathized with in the system speech t(9), the dialogue system makes a speech “I love having a cherry-blossom viewing party. How are cherry blossoms in Nagatoro?” in the system speech t(7) to ask a question about the user's evaluation of the cherry blossoms in Nagatoro. This is because, if the system speech t(7) is presented to the user, the user should talk about their evaluation of cherry blossoms in the famous place for a cherry-blossom viewing party in Nagatoro. In order to elicit the user speech t(6) that contains information regarding the user's experience that is to be used to make the system speech t(7) that asks for an evaluation, the dialogue system makes the system speech t(5) “I'd like to go there. Nagatoro is famous, isn't it?” that asks the user about their experience of visiting Nagatoro. This is because, if the system speech t(5) is presented to the user, the user should talk about their experience of visiting Nagatoro.

Since people have various evaluation expressions, when a user freely makes a speech regarding an evaluation, it is possible that a system speech that appropriately sympathizes with the evaluation cannot be generated. On the other hand, a person can clearly recognize that the dialogue partner sympathizes with them if the dialogue partner shows a positive evaluation to what they positively evaluate. Similarly, a person can clearly recognize that the dialogue partner sympathizes with them if the dialogue partner shows a negative evaluation to what they negatively evaluate. Therefore, according to the dialogue method carried out by the dialogue system according to the present invention, the user is first prompted to speak about experience to which a positive evaluation or negative evaluation is to be made, and thereafter the subject of the user speech is narrowed down to the positive evaluation or the negative evaluation of the experience.

That is to say, the features of the dialogue method performed by the dialogue system according to the present invention lie in the following two points. The first feature is to present a system speech to elicit information regarding the user's experience in a subject contained in a dialogue (hereinafter also referred to as a “first system speech”) , such as the system speech t (5) , accept a user speech that responds to the first system speech (hereinafter also referred to as a “first user speech”), such as the user speech t(6), and, when the first user speech is a speech that contains the fact that the user has an experience in the subject, present a system speech to elicit information regarding the user's evaluation of the user's experience in the subject (hereinafter also referred to as a “second system speech”), such as the system speech t(7). The second feature is to accept a user speech that responds to the presented second system speech (hereinafter also referred to as a “second user speech”), such as the user speech t(8), and, when the second user speech is a speech that contains the user's positive or negative evaluation of the user's experience in the subject, present a system speech to sympathize with the evaluation (i.e., the positive or negative evaluation) (hereinafter also referred to as a “third system speech”), such as the system speech t(9). With these features, it is possible to give the user the impression that the system has sufficient dialogue capabilities.

[[Example 1-2]] “I'd like to go there. Nagatoro is famous, isn't it?” in System Speech t (5) , “I love having a cherry-blossom viewing party. How are cherry blossoms in Nagatoro?” in System Speech t (7) , and “Isn't it so beautiful?” in System Speech t(9′) in Specific Example 2

Specific Example 2 is the same as Specific Example 1 in making the system speech t(7) to elicit a user speech that contains the user's evaluation, to be sympathized with in a system speech, and making the system speech t(5), saying “I'd like to go there. Nagatoro is famous, isn't it?”, to elicit the speech t(6) that contains the user's experience, which is a speech for asking the user's experience of visiting Nagatoro, to make a speech to ask for their evaluation in the system speech t(7). However, Specific Example 2 is for a case in which the user makes the user speech t(8′), which contains the user's negative evaluation, responding to the system speech t(7). The speech t(9′) saying “Isn't it so beautiful?” is a speech that appropriately sympathizes with the user's negative evaluation of the user's experience expressed in the previous user speech t(8′) saying “Well, I don't know”. As described above, the dialogue system according to the present invention, the dialogues up to the system speech t(7) guide the user to respond to the system speech t(7) so that the user speech contains the user's positive or negative evaluation of the user's experience. Therefore, even if the user's evaluation is not a positive evaluation as in the user speech t(8), but a negative evaluation as in the user speech t(8′), the system can present a speech that appropriately sympathizes with the user speech.

As shown in Examples 2-1 and 2-2 below, it is possible to present a system speech that is constituted by a question that allows for making a speech with a high degree of freedom, and a speech that precedes the question and serves as a strategic move for narrowing down the subject of the user speech, as a speech for eliciting information regarding the user's experience or the user's evaluation of the experience.

[[Example 2-1]] “I'd like to go there” the precedes “Nagatoro is famous, isn't it?” in System Speech t(5)

Responding to the system speech t (5) saying “Nagatoro is famous, isn't it?” in the above specific examples, in the subsequent user speech t(6), the user appears to freely make a speech saying “Nagatoro is close, so I sometimes go there by bicycle” instead of answering whether Nagatoro is famous or not. However, in the system speech t(5), the system shows a strategic move by saying “I′ d like to go there” before asking the question “Nagatoro is famous, isn't it?”, to elicit a user speech that is in line with the system's intention to prompt the user to talk about the user's experience of visiting Nagatoro. That is to say, in the above specific example, while giving the impression that the user is speaking more freely than when the dialogue system directly asks the user whether or not the user has the experience, the dialogue system can elicit information regarding the user's experience as intended by the dialogue system, and connect it to the next system speech, namely the system speech t(7) corresponding to the presence or absence of the user's experience. Such a user speech can be elicited by presenting a system speech that is constituted by a question that allows for making a speech with a high degree of freedom, and a speech that precedes the question and serves as a strategic move for narrowing down the subject of the user speech, as a system speech for eliciting information regarding the user's experience in the subject. As a result, it is possible to give the user the impression that the system has sufficient dialogue capabilities.

[[Example 2-2]] “I love having a cherry-blossom viewing party” in System Speech t(7)

In the above specific examples, responding to the question saying “How are cherry blossoms in Nagatoro?” in the system speech t (7), which may have various answers, the user appears to freely make a speech in the subsequent user speech t(8) or t(8′), saying “The row of cherry blossom trees along the Arakawa River is spectacular, and in the spring, it looks like a tunnel of cherry blossoms” or “Well, I don't know”. However, in the system speech t(7), the system shows a strategic move by saying “I love having a cherry-blossom viewing party” before asking the question “How about the cherry blossoms in Nagatoro?”, to elicit a user speech that is in line with the system's intention to prompt the user to talk about the user's positive or negative evaluation of the experience of seeing cherry blossoms in Nagatoro. That is to say, in the above specific example, while giving the impression that the user is speaking more freely than when the dialogue system directly asks the user whether the user makes a positive evaluation nor a negative evaluation, the dialogue system can elicit information regarding whether the user makes a positive evaluation nor a negative evaluation, as intended by the dialogue system, and connect it to the next system speech, namely the system speech t (9) or t (9′) corresponding to the user's positive or negative evaluation of the user's experience. Such a user speech can be elicited by presenting a system speech that is constituted by a question that allows for making a speech with a high degree of freedom, and a speech that precedes the question and serves as a strategic move for narrowing down the subject of the user speech, as a speech for eliciting information regarding the user's evaluation of the experience. As a result, it is possible to give the user the impression that the system has sufficient dialogue capabilities to correctly understand the user's free speeches.

[Processing Procedures of Dialogue Method Carried Out by Dialogue System 100]

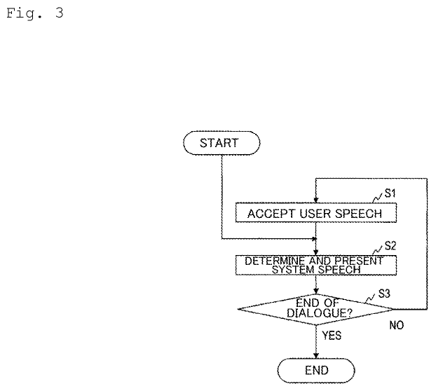

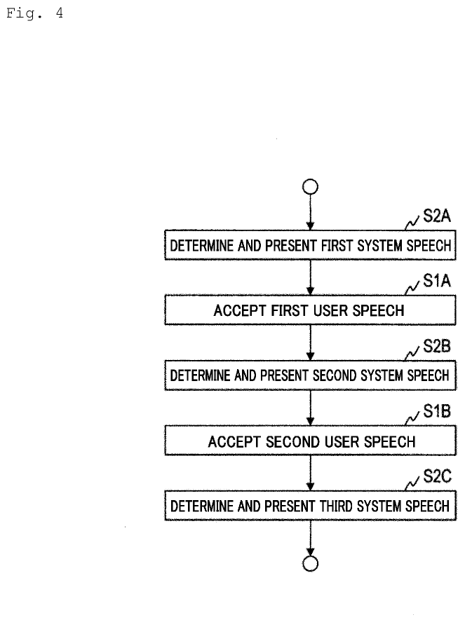

Next, the processing procedures of the dialogue method carried out by the dialogue system 100 according to the first embodiment are as shown in FIG. 3, and an example of a portion thereof corresponding to the feature of the present invention is as shown in FIG. 4.

[Determination and Presentation of System Speech at First time (Step S2 at First Time)]

Upon the dialogue system 100 starting a dialogue operation, first, the system speech generation unit 320 of the speech determination unit 30 reads out a speech template fora system speech to be made in the initial state of the scenario, from the scenario storage unit 350, and outputs a text representing the content of the system speech, and the voice synthesis unit 40 converts the text into a voice signal, and the presentation unit 50 presents the voice signal. The system speech made in the initial state of the scenario is a speech that includes a greeting and asks the user a question as in the system speech t(1), for example.

[Acceptance of User Speech (step S1)]

The input unit 10 collects the user's spoken voice and converts it into a voice signal, and the voice recognition unit 20 converts the voice signal into a text and outputs the text representing the content of the user's speech to the speech determination unit 30. Examples of texts representing the content of the user's speech include the user speech t (2) responding to the system speech t(1), the user speech t (4) responding to the system speech t (3) , the user speech t (6) responding to the system speech t (5) , and the user speech t(8) or t(8′) responding to the system speech t(7).

[Determination and Presentation of System Speech (Step S2 for other than First Time)]

Based on information contained in the previous user speech, the speech determination unit 30 reads out a speech template for a system speech that is to be made in the current state of the scenario, from the scenario storage unit 350, to determine a text representing the content of a system speech, the voice synthesis unit 40 converts the text into a voice signal, and the presentation unit 50 presents the voice signal. System speeches to be presented are the system speech t (3) that responds to the user speech t (2) , the system speech t(5) that responds to the user speech t(4), the system speech t(7) that responds to the user speech t(6), the system speech t(9) that responds to the user speech t (8) , and the system speech t (9′) that responds to the user speech t(8′). The details of step S2 will be described later in [Processing Procedures for System Speech Determination and Presentation].

[Continuation and Termination of Dialogue (Step S3)]

If the current state in the scenario stored in the scenario storage unit 350 is the final state, the system speech generation unit 320 of the speech determination unit 30 operates so that the dialogue system 100 terminates the dialogue operation, and otherwise continues the dialogue by performing step S1.

[Portion of Processing Procedures Corresponding to Features of Present Invention, of Dialogue Method Carried Out by Dialogue System 100]

The portion corresponding to the features of the present invention, of the dialogue method carried out by the dialogue system 100, is, as shown in FIG. 4, step S2A, which is step S2 that is to be performed at the first time, step S1A, which is step S1 that is to be performed after step S2A, Step S2B, which is step S2 that is to be performed after step S1A, Step S1B, which is step S1 that is to be performed after step S2B, and Step S2C, which is step S2 performed after step S1B, which are carried out in order. Note that the dialogue system 100 performs step S2A when the current state of the dialogue that is based on a scenario stored in the scenario storage unit 350 is the state in which the dialogue system 100 is to make a speech to elicit a user speech regarding the user's experience.

[Determination and Presentation of First System Speech (Step S2A)]

The speech determination unit 30 reads out a speech template that contains a speech for eliciting information regarding the user's experience (the first system speech) from the scenario storage unit 350, and determines a text representing the content of the system speech. The determined text representing the content of the system speech is converted by the voice synthesis unit 40 into a voice signal, and the voice signal is presented by the presentation unit 50. An example of the text representing the system speech for eliciting information regarding the user's experience (the first system speech) when the subject is cherry blossoms in Nagatoro is a speech that asks about a visiting experience such as “I'd like to go there. Nagatoro is famous, isn't it?” contained in the speech t(5).

[Acceptance of First User Speech (step S1A)]

The input unit 10 collects the user's spoken voice of the user speech (the first user speech) that responds to the system speech for eliciting information regarding the user's experience (the first system speech) and converts it into a voice signal, and the voice recognition unit 20 converts the voice signal into a text and outputs the text representing the content of the user speech to the speech determination unit 30. An example of the text representing the user speech (the first user speech) that responds to the system speech for eliciting information regarding the user's experience (the first system speech) is the speech t(6) saying “Nagatoro is close, so I sometimes go there by bicycle”.

[Determination and Presentation of Second System Speech (Step S2B) ]

When the first user speech is a speech that contains the fact that the user has an experience in the subject of the first system speech, the speech determination unit 30 reads out a speech template that contains a system speech for eliciting information regarding the user's evaluation of the user's experience in the subject (the second system speech) from the scenario storage unit 350, and determines a text representing the content of the system speech. The determined text representing the content of the system speech is converted by the voice synthesis unit 40 into a voice signal, and the voice signal is presented by the presentation unit 50. An example of a text representing the content of a system speech for eliciting information regarding the user's evaluation of the user's experience (the second system speech) is a speech that asks about the user's evaluation of cherry blossoms in Nagatoro, such as “I love having a cherry-blossom viewing party. How are cherry blossoms in Nagatoro?” contained in the system speech t(7).

[Acceptance of Second User Speech (step S1B)]

The input unit 10 collects the user's spoken voice of the user speech (the second user speech) that responds to the system speech for eliciting information regarding the user's evaluation of the user's experience (the second system speech) and converts it into a voice signal, and the voice recognition unit 20 converts the voice signal into a text and outputs the text representing the content of the user speech to the speech determination unit 30. An example of the text representing the content of the user speech (the second user speech) that responds to the system speech for eliciting information regarding the user's evaluation of the user's experience (the second system speech) is the user speech t (8) saying “The row of cherry blossom trees along the Arakawa River is spectacular, and in the spring, it looks like a tunnel of cherry blossoms” and the user speech t(8′) saying “Well, I don't know”.

[Determination and Presentation of Third System Speech (Step S2C)]

When the second user speech is a speech that contains the user's positive or negative evaluation of the user's experience in the subject of the first system speech, the speech determination unit 30 reads out a speech template that contains a system speech for sympathizing with the user's evaluation (i.e., the positive or negative evaluation) (the third system speech) from the scenario storage unit 350, and determines a text representing the content of the system speech. The determined text representing the content of the system speech is converted by the voice synthesis unit 40 into a voice signal, and the voice signal is presented by the presentation unit 50. Examples of the text representing the content of the system speech for sympathizing with the user's positive or negative evaluation (the third system speech) include a speech for sympathizing with the user's positive evaluation, such as “I love cherry blossoms” contained in the speech t(9), and a speech for sympathizing with the user's negative evaluation, such as “Isn't it so beautiful?” in the speech t(9′).

[Processing Procedures for System Speech Determination and Presentation]

The details of the processing procedures for system speech determination and presentation (step S2) are as shown in step S21 to step S25 described below.

[Acquisition of Result of User Speech Understanding (step S21)]

The user speech understanding unit 310 acquires the result of understanding of the intention of the user's speech and attribute information regarding the user from the text representing the content of the user speech input to the speech determination unit 30, and outputs them to the system speech generation unit 320. The user speech understanding unit 310 stores the acquired attribute information regarding the user to the user information storage unit 330 as well.

For example, if the text representing the content of the input user speech is the speech t (2) , the user speech understanding unit 310 acquires a result indicating “speech intention=a name is spoken” as the result of understanding of the intention of the user speech, and acquires “Sugiyama”, which is the “user's name”, as attribute information regarding the user. For example, if the text representing the content of the input user speech is the speech t(4), the user speech understanding unit 310 acquires a result indicating “speech intention=a residence prefecture is spoken” as the result of understanding of the intention of the user speech, and acquires “Saitama prefecture”, which is the “user's residence prefecture”, as attribute information regarding the user. If the text representing the content of the input user speech is the speech t(6), the user speech understanding unit 310 acquires a result indicating “speech intention=the presence of the experience of visiting a famous place is spoken” as the result of understanding of the intention of the user speech, and acquires “the experience of visiting a famous place in the user's residence prefecture=YES” as attribute information regarding the user. If the text representing the content of the input user speech is the speech t(8), the user speech understanding unit 310 acquires a result indicating “speech intention=a positive evaluation of the experience in the famous place is spoken” as the result of understanding of the intention of the user speech, and acquires “the user's evaluation of the experience in the famous place in the user's residence prefecture=a positive evaluation”, as attribute information regarding the user. If the text representing the content of the input user speech is the speech t (8′) , the user speech understanding unit 310 acquires a result indicating “speech intention=a negative evaluation of the experience in the famous place is spoken” as the result of understanding of the intention of the user speech, and acquires “the user's evaluation of the experience in the famous place in the user's residence prefecture=a negative evaluation”, as attribute information regarding the user.

Note that step S21 is not performed in the initial step S2.

[Acquisition of Speech Template (Step S22)]

The system speech generation unit 320 acquires a speech template corresponding to the user's speech intention input from the user speech understanding unit 310 from among the speech templates corresponding to the candidates for the speech intention of the previous user speech in the current state in the scenario stored in the scenario storage unit 350.

For example, if the text representing the content of the input user speech is the speech t (2) , the system speech generation unit 320 acquires a speech template saying “You are [user name]. I'm Riko. Nice to meet you. What prefecture do you live in, [user name]?”. Note that the portions in [] (square brackets) in the speech template are information specifying that information is to be acquired from the user speech understanding unit 310 or the user information storage unit 330 and is to be included therein.

Also, for example, if the text representing the content of the input user speech is the speech t(4), the system speech generation unit 320 acquires a speech template saying “I see, Saitama prefecture. I like Saitama. I'd like to go there. Nagatoro is famous, isn't it?”. Also, for example, if the text representing the content of the input user speech is the speech t(6), the system speech generation unit 320 acquires a speech template saying “I'm jealous you have nice cherry blossoms. I love having a cherry-blossom viewing party. How are cherry blossoms in Nagatoro?”.

Also, for example, if the text representing the content of the input user speech is the speech t(8), the system speech generation unit 320 acquires a speech template saying “I love cherry blossoms. By the way, I live in Aomori prefecture, and when it comes to cherry blossoms, I recommend Hirosaki Castle. Have you been there, [user name]?”. On the other hand, if the text representing the content of the input user speech is the speech t (8′) , the system speech generation unit 320 acquires a speech template saying “Isn't it so beautiful?”.

Note that, in step S22 in step S2 at the first time, the system speech generation unit 320 acquires speech template in the initial state of the scenario stored in the scenario storage unit 350.

[System Speech Generation (Step S23)]

If the speech template acquired in step S22 contains information specifying that attribute information of a predetermined type regarding the user, not acquired from the user speech understanding unit 310, is to be included, the system speech generation unit 320 acquires the attribute information of the predetermined type regarding the user from the user information storage unit 330, inserts the acquired information into the speech template at a specified position, and determines and outputs it as a text representing the content of the system speech. If the speech template acquired in step S22 does not contain information specifying that attribute information of a predetermined type regarding the user is to be included, the system speech generation unit 320 determines and outputs the acquired speech template without change as the text representing the content of the system speech.

For example, if the text representing the content of the input user speech is the speech t (2) , the system speech generation unit 320 inserts “Sugiyama”, which is [user name] acquired from the user speech understanding unit 310, into the above-described speech template, determines and outputs it as the text of the speech t(3). If the text representing the content of the input user speech is the speech t (8) , the system speech generation unit 320 acquires “Sugiyama”, which is [user name], from the user information storage unit 330, inserts it into the above-described speech template, and determines and outputs it as the text of the speech t(9).

[System Speech Voice Synthesis (Step S24)]

The voice synthesis unit 40 converts the text representing the content of the system speech input from the speech determination unit 30 into a voice signal representing the content of the system speech, and outputs the voice signal to the presentation unit 50.

[System Speech Presentation (Step S25)]

The presentation unit 50 presents a voice corresponding to a voice signal representing the content of a speech input from the voice synthesis unit 40.

### Second Embodiment

Although an example in which voice dialogue is performed using a humanoid robot as an agent is described in the first embodiment, the presentation unit of the dialogue system according to the present invention may be a humanoid robot having a body or the like, or a robot without a body or the like. Also, the dialogue system according to the present invention is not limited to the above examples, and may be in a form in which dialogue is performed using an agent that does not have an entity such as a body, and does not have a vocalization mechanism, unlike a humanoid robot. Examples of such forms include a form in which a dialogue is performed using an agent that is displayed on a computer screen. More specifically, the present invention is also applicable to a form in which a user's account and a dialogue device's account have a dialogue in a chat such as “LINE” (registered trademark) in which a dialogue is performed through text messages. Such a form will be described as a second embodiment. In the second embodiment, a computer that has a screen for displaying the agent needs to be located in the vicinity of a human, but the computer and the dialogue device may be connected to each other via a network such as the Internet. That is to say, the dialogue system according to the present invention is applicable not only to dialogues in which speakers such as a human and a robot actually talk face to face, but also to conversations in which speakers communicate with each other via a network.

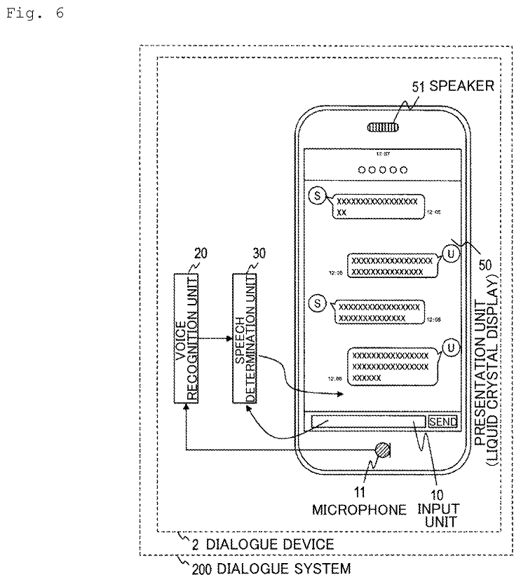

As shown in FIG. 6, a dialogue system 200 according to the second embodiment includes, for example, one dialogue device 2. The dialogue device 2 according to the second embodiment includes, for example, an input unit 10, a voice recognition unit 20, a speech determination unit 30, and a presentation unit 50. The dialogue device 2 may include, for example, a microphone 11 and a speaker 51.

The dialogue device 2 according to the second embodiment is, for example, an information processing device which is, for example, a mobile terminal such as a smartphone or a tablet, or a desktop or laptop personal computer. The following describes a case in which the dialogue device 2 is a smartphone. The presentation unit 50 is a liquid crystal display provided on the smartphone. A chat application window is displayed on this liquid crystal display, and the content of chat dialogue is displayed in the window in chronological order. It is assumed that a virtual account corresponding to the virtual personality controlled by the dialogue device 2 and the user's account participate in this chat. That is to say, the present embodiment is an example in which the agent is a virtual account displayed on the liquid crystal display of the smartphone which is the dialogue device. The user can input the content of a speech to the input unit 10, which is an input area provided in the chat window, using a software keyboard, and post the speech to the chat through their own account. The speech determination unit 30 determines the content of a speech from the dialogue device 2 based on the post from the user's account, and posts the speech to the chat through the virtual account. Note that it is possible to employ a configuration that utilizes the microphone 11 mounted on the smartphone and a voice recognition function to enable the user to input the content of a speech to the input unit 10 by voice. In addition, it is possible to employ a configuration that utilizes the speaker 51 mounted on the smartphone and a voice synthesis function to output the content of a speech acquired from each dialogue system from the speaker 51 with a voice corresponding to each virtual account.

Although embodiments of the present invention have been described above, the specific configuration is not limited to these embodiments, and, as a matter of course, even if the design is changed when necessary, without departing from the spirit of the present invention, such a configuration is also included in the present invention.

[Program and Recording Medium]

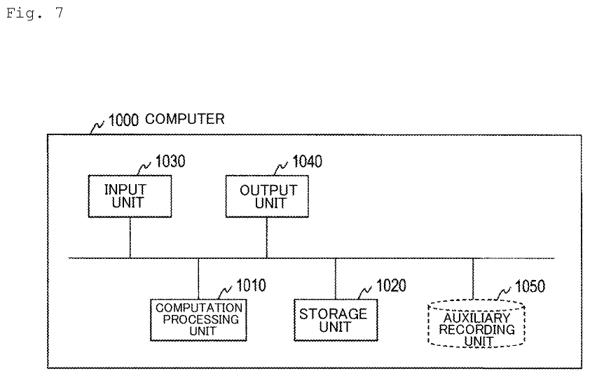

When various processing functions in each dialogue device described in the above embodiments are to be realized using a computer, the contents of processing of the functions that the dialogue device needs to have are to be written as a program. By loading this program to a storage unit 1020 of a computer shown in FIG. 7 to operate a computation processing unit 1010, an input unit 1030, an output unit 1040, and so on, it is possible to realize various processing functions in each of the above-described dialogue devices on the computer.

The program describing the content of processing can be recorded on a computer-readable recording medium. The computer-readable recording medium is, for example, a non-temporary recording medium, and specific examples thereof include a magnetic recording device, an optical disk, and so on.

In addition, the distribution of this program is carried out by, for example, selling, transferring, or renting a portable recording medium such as a DVD or a CD-ROM on which the program is recorded. Furthermore, the program may be stored in a storage device of a server computer, and the program may be distributed by transferring the program from the server computer to another computer via a network.

A computer that executes such a program first transfers a program recorded on the portable recording medium or a program transferred from the server computer to an auxiliary recording unit 1050, which is a non-transitory storage device thereof, for example. When processing is to be executed, the computer reads the program stored in the auxiliary recording unit 1050, which is a non-transitory storage device, into the storage unit 1020, and executes processing according to the read program. In addition, in another execution form of this program, the computer may read the program directly from a portable recording medium into the storage unit 1020 and execute processing according to the program. Also, the computer may sequentially execute processing according to a received program each time a program is transferred from a server computer to this computer. In addition, it is possible to employ a configuration with which the above processing is executed by a so-called ASP (Application Service Provider) type service that realizes processing functions by using an instruction to executing the program and acquiring the result, without transferring the program from the server computer to this computer. Note that the program in such a form includes information that is to be used by a computer to perform processing, and is equivalent a program (for example, data that is not a direct command to a computer, but has properties of defining processing to be performed by the computer) .

In addition, although the present device in such a form is formed by executing a predetermined program on a computer, at least a part of the content of such processing may be realized using hardware.

1. A computer-implemented method for setting a personality of an agent in a dialogue, comprising:
presenting a first speech to elicit information regarding a user's experience in a subject contained in a dialogue;
accepting a first user speech that responds to the first speech presented;
presenting a second speech to elicit information regarding the user's evaluation of the user's experience in the subject when the first user speech that contains a fact that a user has an experience in the subject;
accepting a third user speech; and
when the third user speech contains the user's positive or negative evaluation of the user's experience in the subject, presenting a fourth speech to sympathize with the positive or negative evaluation of the user's experience in the subject.

2. The computer-implemented method according to claim 1,
wherein the first speech contains a question about an impression of the subject and another speech that precedes the question and expresses a desire to have the experience.

3. The computer-implemented method according to claim 1,
wherein the second speech includes a question about an impression of the subject and a preceding speech that precedes the question and employs an evaluation expression.

4. A system for setting a personality an agent in a dialogue, the system comprising a circuit configured to execute a method comprising:
presenting a first system speech that is a first speech for eliciting a first user speech regarding a user's experience in a subject contained in a dialogue;
presenting a second system speech that is a second speech to be presented when the first user speech that responds to the first system speech contains a fact that a user has an experience in the subject, to elicit information regarding the user's evaluation of the user's experience in the subject;
presenting a third system speech that is a third speech to be presented when a second user speech that responds to the second system speech contains the user's positive or negative evaluation of the user's experience in the subject, to sympathize with the positive or negative evaluation;
accepting the first user speech; and
accepting the second user speech.

5. A dialogue device for determining speech, the dialogue device comprising a circuit configured for setting a personality to an agent in a dialogue to execute a method comprising:
determining a first system speech that is a first speech for eliciting a first user speech regarding a user's experience in a subject contained in a dialogue;
determining a second system speech that is a second speech to be presented when first user speech that responds to the first system speech contains a fact that a user has an experience in the subject, to elicit information regarding the user's evaluation of the user's experience in the subject; and
determining a third system speech that is a third speech to be presented when a second user speech that responds to the second system speech contains the user's positive or negative evaluation of the user's experience in the subject, to sympathize with the positive or negative evaluation.

6-7. (canceled)

8. The computer-implemented method according to claim 1, wherein the agent represents at least one of:
a humanoid robot, or
a virtual chat partner set on a computer display.

9. The computer-implemented method according to claim 2, wherein the second speech includes a question about an impression of the subject and a preceding speech that precedes the question and employs an evaluation expression.

10. The system according to claim 4, wherein the first speech contains a question about an impression of the subject and another speech that precedes the question and expresses a desire to have the experience.

11. The system according to claim 4, wherein the second speech includes a question about an impression of the subject and a preceding speech that precedes the question and employs an evaluation expression.

12. The system according to claim 4, wherein the agent represents at least one of:
a humanoid robot, or
a virtual chat partner set on a computer display.

13. The system according to claim 10, wherein the second speech includes a question about an impression of the subject and a preceding speech that precedes the question and employs an evaluation expression.

14. The dialogue device according to claim 5, wherein the first speech contains a question about an impression of the subject and another speech that precedes the question and expresses a desire to have the experience.

15. The dialogue device according to claim 5, wherein the second speech includes a question about an impression of the subject and a preceding speech that precedes the question and employs an evaluation expression.

16. The dialogue device according to claim 5, wherein the agent represents at least one of:
a humanoid robot, or
a virtual chat partner set on a computer display.

17. The dialogue device according to claim 14, wherein the second speech includes a question about an impression of the subject and a preceding speech that precedes the question and employs an evaluation expression.
